(19) United States
(12) Patent Application Publication
(10) Pub. No.: US 2003/0005306 A1
(43) Pub. Date: Jan. 2, 2003

(54) Message digest based data synchronization

(76) Inventors: Preston J. Hunt, Portland, OR (US); Narayan R. Manepally, Beaverton, OR (US)

Correspondence Address: BLAKELY, SOKOLOFF, TAYLOR & ZAFMAN LLP, Seventh Floor, 12400 Wilshire Boulevard, Los Angeles, CA, 90025-1026, US

(21) Appl. No.: 09/896,321

(22) Filed: Jun. 29, 2001

(51) Int. Cl. H04L 9/00

(52) U.S. Cl. 713/181

(57) ABSTRACT

A method and apparatus are described for data synchronization between a client and a repository. According to one embodiment, data synchronization between a client and a repository is performed based on the results of a comparison between message digests associated with files stored on the client and a database of message digests stored on the repository. The message digests generated on the client uniquely identify the content of files stored on the client. This unique identification of the contents of the files on the client is accomplished by performing a cryptographic hash of the contents of the individual files. The database of message digests stored on the repository contains message digests from clients that are stored in the database at the time of data synchronization. By comparing message digests generated on the client with those stored on the repository, the need for data synchronization may be efficiently determined.

### FIELD OF THE INVENTION

The invention relates generally to the field of computer networks. More particularly, the invention relates to synchronizing data between a client and a data repository based on a message digest.

### BACKGROUND OF THE INVENTION

On a computer network, such as the Internet, users may want to store or archive data from one device on another device. For example, a user may wish to store copies of content on a server for distribution and use by others. In other applications users may wish to distribute and store copies of content on particular servers of the network, such as those located at the edge of the network. In still other applications a user may wish to backup content on the user's machine to a server for storage. In any of these applications, the users are likely to periodically refresh the content of the archive. That is, the client, or user's machine should be periodically synchronized with the server or archive repository to assure that the content matches. However, when performing this synchronization, it is not efficient to copy content that already matches. Only files that have been changed, added, or deleted should be copied.

Previous methods of preventing the unnecessary copying of content in such a situation have included comparing file size, file name, and file date of files on the client or user's machine with the file size, file name, and file date of files archived on the server. These methods provide for a fast determination since simply comparing file names, file sizes, and file dates can be performed very quickly. For example, a file compare based on these attributes would require transferring on the order of 10¹ to 10² bytes. However, these methods may not be able to properly determine which files should be synchronized. First of all, file name, file size, and file date are not indicative of the contents of the file. Two files may have the same name, size and date but have different content. Secondly, these attributes can be easily changed. A change in the name, size or date of one copy of a file stored on a client but no corresponding change of the matching attribute of a copy of the file stored in a repository will result in a false determination that the files are different. Similarly, a change of file name, size, or date for a file stored on a client, such that these attributes now coincidentally match those of a file in a repository may result in a false determination that the files are the same.

Another method of preventing the unnecessary copying of content when synchronizing a client with a repository involves comparing the actual content of the files. In this case, the contents of files stored on a client are directly compared with the contents of files archived in the repository. If the contents of a file are found to be different between the client and repository, that file will be copied. However, depending on the number and size of the files involved this method may take a considerable amount of time and waste available network bandwidth. For example, a comparison of the contents of a 10 GB file would require transferring on the order of 10¹⁰ bytes for the one file.

### BRIEF DESCRIPTION OF THE DRAWINGS

The appended claims set forth the features of the invention with particularity. The invention, together with its advantages, may be best understood from the following detailed description taken in conjunction with the accompanying drawings of which:

FIG. 1 is a block diagram illustrating a typical computer system upon which embodiments of the present invention may be implemented;

FIG. 2 is a block diagram illustrating a conceptual view of message digest based data synchronization according to one embodiment of the present invention;

FIG. 3 is a flowchart illustrating a high-level view of message digest based data synchronization processing according to one embodiment of the present invention;

FIG. 4 is a flowchart illustrating message digest generation according to one embodiment of the present invention;

FIG. 5 is a flowchart illustrating a data synchronization process according to one embodiment of the present invention;

FIG. 6 is a flowchart illustrating a synchronization verification process according to one embodiment of the present invention; and

FIG. 7 is a flowchart illustrating a process for calculating a single message digest for multiple files.

### DETAILED DESCRIPTION OF THE INVENTION

A method and apparatus are described for data synchronization between a client and a repository. According to one embodiment of the present invention, data synchronization between a client and a repository is performed based on the results of a comparison between message digests associated with files stored on the client and a database of message digests stored on the repository. The message digests generated on the client uniquely identify the content of files stored on the client. This unique identification of the contents of the files on the client is accomplished by performing a cryptographic hash of the contents of the individual files. The database of message digests stored on the repository contains message digests from clients that are stored in the database at the time of data synchronization. The need for data synchronization between the client and repository may be efficiently determined based on a comparison of the message digests generated on the client and corresponding message digests from the database of message digests on the repository.

In the following description, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form.

Throughout the following discussion, the terms “message digest”, “digest”, “cryptographic hash”, and “hash” are all used interchangeably. These terms all refer to a message digest that can be defined as the representation of the contents of a file in the form of a single string of digits created using a one-way hash function. That is, a file of arbitrary length is operated upon by a one-way hash function that generates a message digest of fixed length that uniquely identifies the contents of that file.

The present invention includes various processes, which will be described below. The present invention may be performed by hardware components or may be embodied in machine-executable instructions, which may be used to cause a general-purpose or special-purpose processor or logic circuits programmed with the instructions to perform the processes. Alternatively, the processes may be performed by a combination of hardware and software.

The present invention may be provided as a computer program product which may include a machine-readable medium having stored thereon instructions which may be used to program a computer (or other electronic devices) to perform a process according to the present invention. The machine-readable medium may include, but is not limited to, floppy diskettes, optical disks, CD-ROMs, and magneto-optical disks, ROMs, RAMs, EPROMs, EEPROMs, magnetic or optical cards, flash memory, or other type of media/machine-readable medium suitable for storing electronic instructions. Moreover, the present invention may also be downloaded as a computer program product, wherein the program may be transferred from a remote computer to a requesting computer by way of data signals embodied in a carrier wave or other propagation medium via a communication link (e.g., a modem or network connection).

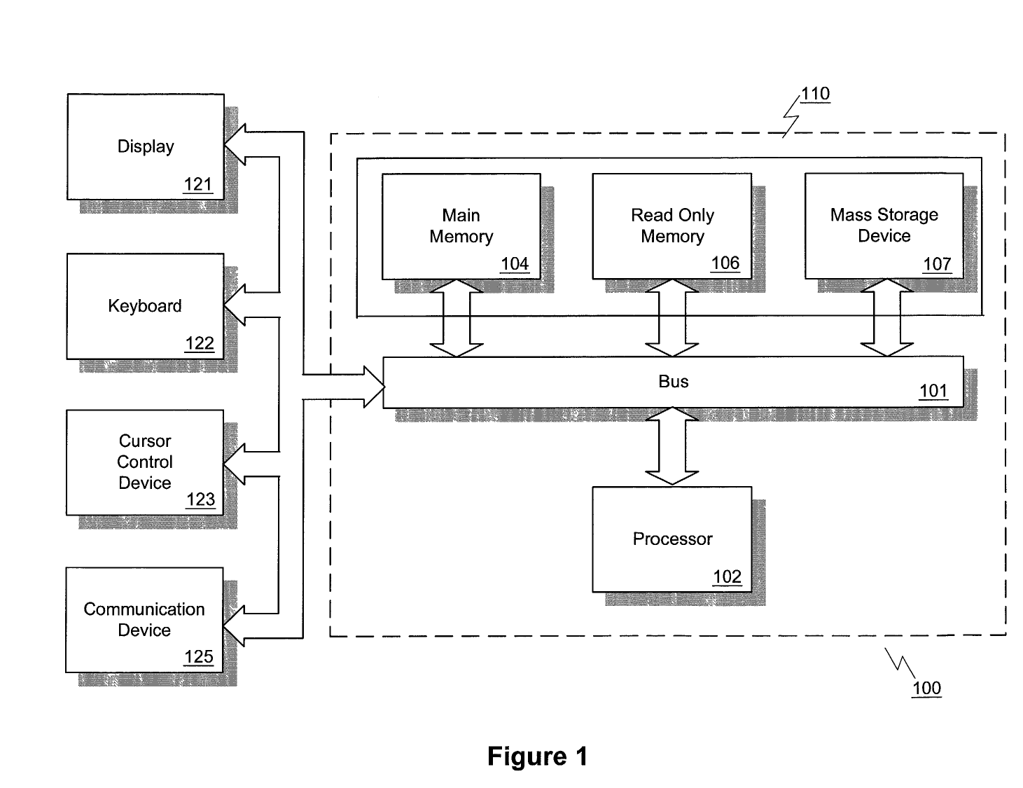

FIG. 1 is a block diagram illustrating a typical computer system upon which one embodiment of the present invention may be implemented. Computer system 100 comprises a bus or other communication means 101 for communicating information, and a processing means such as processor 102 coupled with bus 101 for processing information. Computer system 100 further comprises a random access memory (RAM) or other dynamic storage device 104 (referred to as main memory), coupled to bus 101 for storing information and instructions to be executed by processor 102. Main memory 104 also may be used for storing temporary variables or other intermediate information during execution of instructions by processor 102. Computer system 100 also comprises a read only memory (ROM) and/or other static storage device 106 coupled to bus 101 for storing static information and instructions for processor 102.

A data storage device 107 such as a magnetic disk or optical disc and its corresponding drive may also be coupled to computer system 100 for storing information and instructions. Computer system 100 can also be coupled via bus 101 to a display device 121, such as a cathode ray tube (CRT) or Liquid Crystal Display (LCD), for displaying information to an end user. Typically, an alphanumeric input device 122, including alphanumeric and other keys, maybe coupled to bus 101 for communicating information and/or command selections to processor 102. Another type of user input device is cursor control 123, such as a mouse, a trackball, or cursor direction keys for communicating direction information and command selections to processor 102 and for controlling cursor movement on display 121.

A communication device 125 is also coupled to bus 101. The communication device 125 may include a modem, a network interface card, or other well known interface devices, such as those used for coupling to Ethernet, token ring, or other types of physical attachment for purposes of providing a communication link to support a local or wide area network, for example. In this manner, the computer system 100 may be coupled to a number of clients and/or servers via a conventional network infrastructure, such as a company's Intranet and/or the Internet, for example.

It is appreciated that a lesser or more equipped computer system than the example described above may be desirable for certain implementations. Therefore, the configuration of computer system 100 will vary from implementation to implementation depending upon numerous factors, such as price constraints, performance requirements, technological improvements, and/or other circumstances.

It should be noted that, while the steps described herein may be performed under the control of a programmed processor, such as processor 102, in alternative embodiments, the steps may be fully or partially implemented by any programmable or hardcoded logic, such as Field Programmable Gate Arrays (FPGAs), TTL logic, or Application Specific Integrated Circuits (ASICs), for example. Additionally, the method of the present invention may be performed by any combination of programmed general purpose computer components and/or custom hardware components. Therefore, nothing disclosed herein should be construed as limiting the present invention to a particular embodiment wherein the recited steps are performed by a specific combination of hardware components.

As stated above, users of computers connected to a network may want to store or archive data from one device on another device. When information is cached in such a manner, the users are likely to periodically refresh the content of the archive. That is, the client, or user's machine should be periodically synchronized with the server or archive repository to assure that the content matches. However, when performing this synchronization, it is not efficient to copy content that is already up-to-date, e.g., already matches. Only files that have been changed, added, or otherwise modified on the client should be copied.

Previous methods that have sought to prevent the unnecessary copying of content in such a situation have included comparing file size, file name, file date, and contents of files on the client or user's machine with the file size, file name, file date, and contents of files archived on the server or using binary bit comparisons of the file contents. However, these methods may not be able to properly determine which files should be synchronized or, depending on the number and size of the files involved, may take a considerable amount of time to perform and waste network bandwidth. For example, a file compare based on attributes such as file size, file name, and file date would require transferring on the order of 10¹ to 10² bytes for each file. However, a comparison of the contents of a 10 GB file would require transferring on the order of 10¹⁰ bytes for the one file.

According to one embodiment of the present invention, data synchronization between a client and a repository is performed based on message digests associated with files stored on the client and a database of corresponding message digests stored on the repository. The message digests stored on the client uniquely identify the content of individual files stored on the client. This unique identification of the contents of the files on the client is accomplished by performing a cryptographic hash of the contents. The database of message digests stored on the repository contains message digests associated with files on various clients and are stored in the database at the time of data synchronization. Data synchronization between the client and repository is then based on a comparison of the message digests stored on the client and corresponding message digests from the database of message digests on the repository.

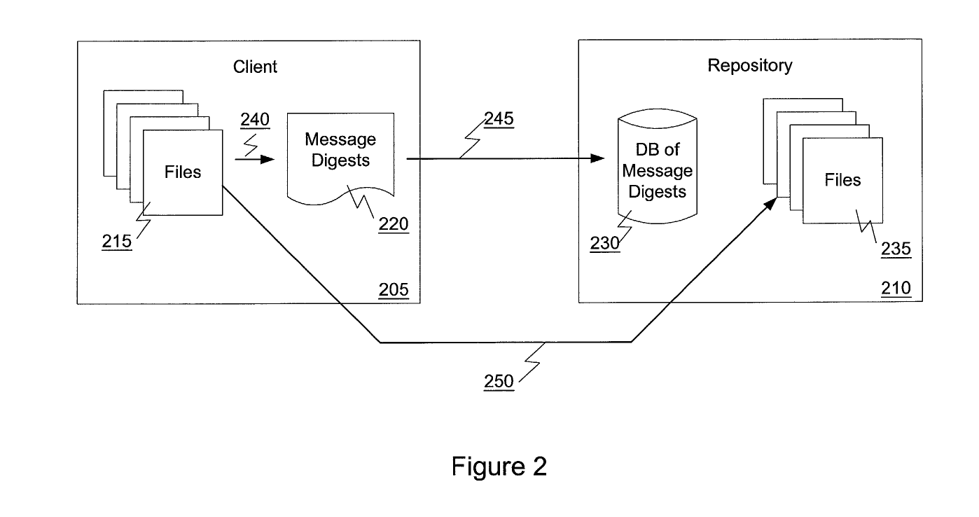

FIG. 2 is a block diagram illustrating a conceptual view of message digest based data synchronization according to one embodiment of the present invention. In this example, a client 205 is connected to a repository 210 via a network (not shown). Files 215 stored on the client 205 may be cached 235 on the repository 210. All files 215 stored on the client 205 that are to be cached on the repository 210 are cataloged 240 in a message digest 220 stored on the client 205. In some applications, not all files on the client 205 will be cached on the repository 210. That is, in some cases the files 215 to be cached may comprise a subset of all files on the client 205. This subset may be defined in various manners. For example, the subset may be only those files stored in specific directories on the client.

According to one embodiment of the present invention, the message digest 220 is originally generated on the client 205 when the first cache operation is performed. Later, message digests 220 will be generated when synchronization operations are performed. The message digest 220 provides a unique identifier based on the contents of each file 215 stored on the client 205 that should be cached on the repository 210. According to one embodiment of the present invention, the message digest is generated using a cryptographic hash function such as the well-known Message Digest 5 (MD5) algorithm or Secure Hash Algorithm (SHA) wherein the contents of the file are hashed to generate the message digest. That is, a cryptographic hash function generates a unique “fingerprint” identifying the contents of each file 215 on the client 205 that is to be cached on the repository 210. By using a cryptographic hash function a relatively short but highly unique identifier, in the form of a message digest, is generated based on the contents of the file. For example, a 160 bit cryptographic hash of a file has a probability of an accidental match of 1:2¹⁶⁰. Additionally, such a hash would provide a short, 20 byte long identifier for a file of any size thereby allowing for very quick comparisons.

When files 215 from the client 205 are initially cached 250 on the repository 210, the message digest 220 from the client 205 is copied to the database of message digests 230 stored on the repository 210. Later, when the client 205 and repository 210 are synchronized, the message digest 220 generated on the client is compared to the database of message digests 230 stored on the repository 210. Only those files that have a digest that does not match the corresponding digest stored in the database of message digests will be copied to the repository. In this manner, the determination of which files to copy is based on an efficient comparison of relatively short, highly unique identifiers.

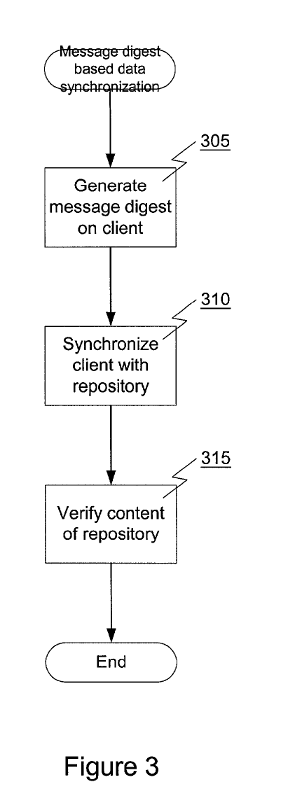

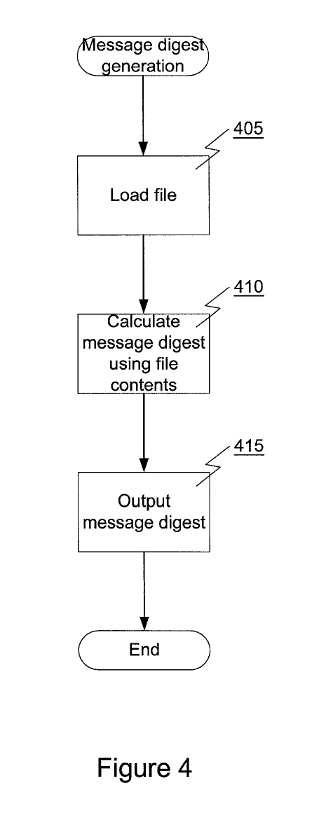

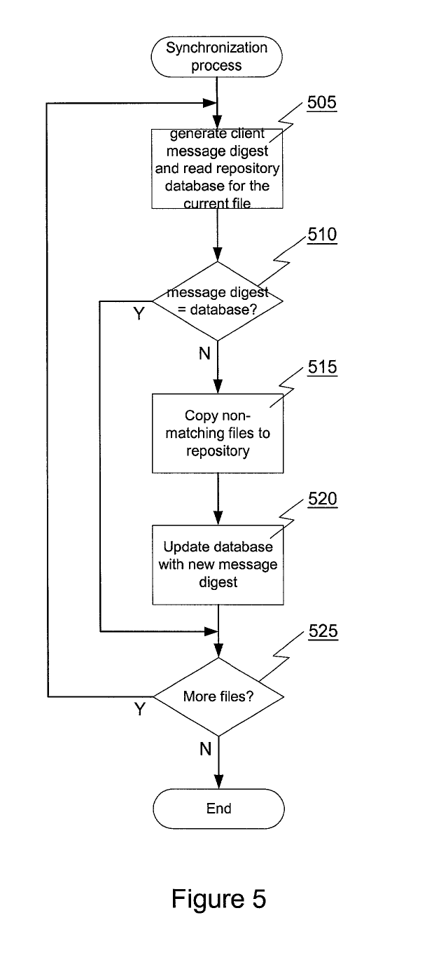

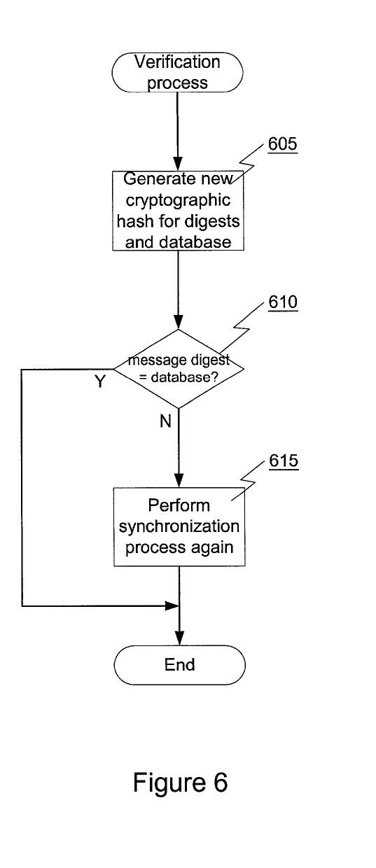

FIG. 3 is a flowchart illustrating a high-level view of message digest based data synchronization processing according to one embodiment of the present invention. Initially, at processing block 305, a message digest is generated on the client. Details of message digest generation will be discussed in greater detail below with reference to FIG. 4. Next, at processing block 310, the client and repository are synchronized. Details of the synchronization process will be discussed in greater detail below with reference to FIG. 5. Finally, at processing block 315, the content of the repository is verified. Details of the verification process will be discussed in greater detail below with reference to FIG. 6.

FIG. 4 is a flowchart illustrating message digest generation according to one embodiment of the present invention. First, at processing block 405, a file to be cached on the repository is loaded. Next, at processing block 410, a unique message digest is generated for each file on the client to be cached on the repository. As explained above, the message digest can be generated using a cryptographic hash function such as the well-known Message Digest 5 (MD5) algorithm or Secure Hash Algorithm (SHA). In either case, the contents of the file are hashed to generate the unique message digest identifying the contents of the file. Finally, at processing block 415, the message digest is output either to be saved in a file on the client or to be compared to a message digest from the database of message digests on the repository as will be described in more detail below.

FIG. 5 is a flowchart illustrating a data synchronization process according to one embodiment of the present invention. In general, synchronization involves comparing message digests from the client to corresponding message digests from the database of message digests from the repository and copying those files whose message digests do not match. First, at processing block 505, the message digest corresponding to the current file is generated on the client and the corresponding entry in the database of message digests is read from the repository. The message digest from the client and the corresponding entry from the database of message digests from the repository are then compared at decision block 510. If the message digest and the database match at decision block 510, no further processing is required for the current file. If, at decision block 510, the message digest and the database do not match, the files corresponding to the non-matching elements of the message digest are copied or marked for later copying to the repository at processing block 515 and the database of message digests on the repository is updated at processing block 520 by copying the message digest from the client to the database of message digests on the repository.

FIG. 6 is a flowchart illustrating a synchronization verification process according to one embodiment of the present invention. First, at processing block 605, cryptographic hashes of the contents of the message digest stored on the client and the corresponding entry in the database of message digests stored on the repository are generated. These hashes are then compared at decision block 610. If the hashes do not match, the synchronization process, as described above with reference to FIG. 5, is repeated at processing block 615.

That is, message digests are generated for all files on the client that will be cached on the repository. A message digest is then generated for the list of these message digests. This message digest uniquely represents the contents of all files on the client to be cached on the repository. Another message digest is generated for the contents of the database of message digests stored on the repository. These two message digests art then compared to verify the contents of the repository. In alternative embodiments, this method may be performed prior data synchronization to determine whether synchronization is needed. By generating a message digest for a list of message digests of all files on the client and a message digest for the contents of the database of message digests on the repository, the contents of the client and repository can be compared quickly by simply comparing the two message digests.

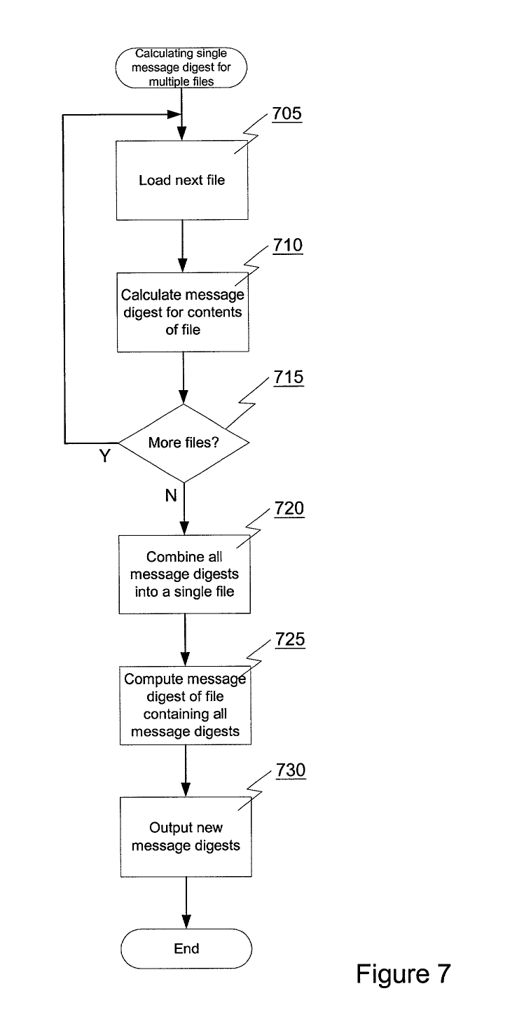

FIG. 7 is a flowchart illustrating a process for calculating a single message digest for multiple files. First, at processing block 705, a file is loaded. At processing block 710, a message digest is calculated for the file. This process can be the same as that described above with reference to FIG. 4. This process is repeated for each file to be cached on the repository. At decision block 715, after a message digest has been generated for all files to be cached on the repository, processing continues at processing block 720 where all message digests for the individual files are combined into a single file. This can be achieved by simply writing the individual message digests to a new file. Alternatively, the message digests can be written to a file as soon as they are generated at processing block 710. Continuing at processing block 725, a message digest is generated for the file containing the message digests for the individual files. Again, this process can be the same as that described with reference to FIG. 4. Finally, at processing block 730, the new message digest for the multiple files can be output either to be saved in a file on the client or to be compared to a similar message digest calculated from the database of message digests on the repository.

What is claimed is:

1. A method comprising:
generating a message digests on a client connected with a network wherein said message digests uniquely identify contents of files stored on the client;
synchronizing contents of said client with a repository connected with the network based on contents of the message digests on the client and corresponding entries in a database of message digests stored on the repository; and
verifying that the contents of the repository match the contents of the client.

2. The method of claim 1, further comprising storing the message digests on the client after generating the message digests.

3. The method of claim 2, further comprising generating new message digests for all files on the client to be cached on the repository prior to data synchronization.

4. The method of claim 1, wherein said files stored on the client comprise a subset of all files stored on the client.

5. The method of claim 4, wherein said subset comprises only files stored in specified directories.

6. The method of claim 1, wherein said generating message digests comprises generating a cryptographic hash for each file to be synchronized.

7. The method of claim 6, wherein said cryptographic hash comprises 128 to 160 bits.

8. The method of claim 1, wherein said synchronizing contents of said client with a repository comprises:
generating a first message digest for a file stored on the client;
reading a second message digest from the database of message digests from the repository corresponding to the first message digest;
comparing the first message digest to the second message digest;
determining whether contents of the client match contents of the repository based on said comparing the first message digest to the second message digest;
copying files from the client to the repository if the files are not found on the repository or do not match the files found on the repository; and
updating the database of message digests on the repository by copying the message digest from the client to the database on the repository.

9. The method of claim 1, wherein said verifying that the contents of the repository match the contents of the client comprises:
generating a first cryptographic hash from a list of message digests for all files on the client to be cached on the repository;
generating a second cryptographic hash from the contents of the database of message digests from the repository;
comparing the first and second cryptographic hash; and
repeating client and repository synchronization if the first and second cryptographic hashes do not match.

10. A system comprising:
a repository server connected with a network, to function as a data repository on behalf of a client; and
the client connected with said repository server via the network, wherein said client
generates a plurality of message digests that each uniquely identify the content of a corresponding file stored on the client,
synchronizes contents of said client with files stored in the repository server based on contents of the message digests on the client and a database of message digests stored on the repository, and
verifies whether the contents of the repository match the contents of the client.

11. The system of claim 10, wherein said generating a plurality of message digests comprises performing a cryptographic hash for each file to be synchronized.

12. The system of claim 11, wherein said cryptographic hash comprises 128 to 160 bits.

13. The system of claim 10, wherein said client:
reads a first message digest generated on the client;
reads a second message digest from the database of message digests from the repository corresponding to the first message digest;
compares the first message digest to the second message digest;
determines whether contents of the client match contents of the repository based on said comparing the first message digest to the second message digest;
copies files from the client to the repository if the files are not found on the repository or do not match the files found on the repository; and
updates the database of message digests on the repository by copying the message digest from the client to the database on the repository.

14. The system of claim 10, wherein said client:
generates a first cryptographic hash from the message digest on the client;
generates a second cryptographic hash from the database of message digests from the repository;
compares the first and second cryptographic hash; and
repeats client and repository synchronization if the first and second cryptographic hashes do not match.

15. A system comprising:
a client connected with a repository server via a network, wherein said client generates a plurality of message digests that each uniquely identify the content of a corresponding file stored on the client; and
the repository server connected with the network, to function as a data repository on behalf of the client, wherein said repository server
synchronizes contents of said client with files stored in the repository server based on contents of the message digests on the client and a database of message digests stored on the repository, and
verifies whether the contents of the repository match the contents of the client.

16. The system of claim 15, wherein said generating a plurality of message digests comprises performing a cryptographic hash for each file to be synchronized.

17. The system of claim 16, wherein said cryptographic hash comprises 128 to 160 bits.

18. The system of claim 15, wherein said repository server:
reads a first message digest generated on the client;
reads a second message digest from the database of message digests from the repository corresponding to the first message digest;
compares the first message digest to the second message digest;
determines whether contents of the client match contents of the repository based on said comparing the first message digest to the second message digest;
copies files from the client to the repository if the files are not found on the repository or do not match the files found on the repository; and
updates the database of message digests on the repository by copying the message digest from the client to the database on the repository.

19. The system of claim 15, wherein said repository server:
generates a first cryptographic hash from the message digest on the client;
generates a second cryptographic hash from the database of message digests from the repository;
compares the first and second cryptographic hash; and
repeats client and repository synchronization if the first and second cryptographic hashes do not match.

20. A machine-readable medium having stored thereon data representing sequences of instructions, said sequences of instructions which, when executed by a processor, cause said processor to:
generate message digests on a client connected with a network wherein said message digests uniquely identify contents of files stored on the client;
synchronize contents of said client with a repository connected with the network based on contents of the message digests on the client and corresponding entries in a database of message digests stored on the repository; and
verify that the contents of the repository match the contents of the client.

21. The machine-readable medium of claim 20, wherein said client stores the message digests on the client after generating the message digests.

22. The machine-readable medium of claim 21, wherein said client generates new message digests for all files on the client to be cached on the repository prior to data synchronization.

23. The machine-readable medium of claim 20, wherein said files stored on the client comprise a subset of all files stored on the client.

24. The machine-readable medium of claim 23, wherein said subset comprises only files stored in specified directories.

25. The machine-readable medium of claim 20, wherein said client generates a cryptographic hash for each file to be synchronized;

26. The machine-readable medium of claim 25, wherein said cryptographic hash comprises 128 to 160 bits.

27. The machine-readable medium of claim 20, wherein said client:
generates a first message digest for a file stored on the client;
reads a second message digest from the database of message digests from the repository corresponding to the first message digest;
compares the first message digest to the second message digest;
determines whether contents of the client match contents of the repository;
copies files from the client to the repository if the files are not found on the repository or do not match the files found on the repository; and
updates the database of message digests on the repository by copying the message digest from the client to the database on the repository.

28. The machine-readable medium of claim 20, wherein said client:
generates a first cryptographic hash from a list of message digests for all files on the client to be cached on the repository;
generates a second cryptographic hash from the contents of the database of message digests from the repository;
compares the first and second cryptographic hash; and
repeats client and repository synchronization if the first and second cryptographic hashes do not match.
